(19) United States
(12) Patent Application Publication
(10) Pub. No.: US 2019/0281112 A1
(43) Pub. Date: Sep. 12, 2019

(54) SYSTEM AND METHOD FOR ORCHESTRATING CLOUD PLATFORM OPERATIONS

(71) Applicant: Nutanix, Inc., San Jose, CA (US)

(72) Inventors: Ashish BHAT, Milpitas, CA (US); Ravikanth SAMPRATHI, San Jose, CA (US); Steven Poitras, San Jose, CA (US)

(21) Appl. No.: 15/915,155

(22) Filed: Mar. 8, 2018

(51) Int. Cl. H04L 29/08; G06F 9/455

(52) U.S. Cl. CPC H04L 67/1097; G06F 9/45558; H04L 67/32

(57) ABSTRACT

A system and method includes an orchestration engine to determine workloads associated with operations on cloud platforms. The orchestration engine can receive a request to a universal application programming interface (API) or a request to an API associated with a cloud platform. The orchestration engine can determine the workload associated with the operation, and select one or more cloud platforms to distribute the workload based at least on a policy. The system and method also includes a lifecycle management engine that can receive requests to implement lifecycle rules on an object stored at a cloud platform. The lifecycle management engine can translate received requests to one API into requests to an API associated with a target cloud platform. The lifecycle management engine can receive status of the object from the target cloud platform, and provide the status to the requesting client.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with at least some aspects of the present disclosure, a method is disclosed. The method includes receiving, by a computing system, from a client, a call to an application programming interface (API), the call including a request to carry out at least one cloud platform related operation. The method further includes determining, by the computing system, a workload associated with the request, the workload including one or more cloud platform operations. The method also includes selecting, by the computing system, one or more cloud platforms from a plurality of cloud platforms for executing the one or more cloud platform operations. The method additionally includes assigning, by the computing system, to each cloud platform of the selected one or more cloud platforms a subset of the one or more cloud platform operations. The method further includes translating, by the computing system, each subset of the one or more cloud platform operations into API calls specific to the respective cloud platform of the selected one or more cloud platforms.

In accordance with some other aspects of the present disclosure, a system is disclosed. The system includes a controller communicably coupled to a plurality of cloud platforms. The controller is configured to receive, from a client, a call to an application programming interface (API), the call including a request to carry out at least one cloud platform related operation. The controller is further configured to determine a workload associated with the request, the workload including one or more cloud platform operations. The controller is also configured to select one or more cloud platforms from a plurality of cloud platforms for executing the one or more cloud platform operations. The controller is further configured to assign to each cloud platform of the selected one or more cloud platforms a subset of the one or more cloud platform operations. The controller is also configured to translate each subset of the one or more cloud platform operations into API calls specific to the respective cloud platform of the selected one or more cloud platforms.

In accordance with at least some aspects of the present disclosure, a method is disclosed. The method includes receiving, by a computing system, from a client, a call to a first application programming interface (API) associated with a first cloud platform, the call including a request to implement at least one lifecycle rule on an object. The method further includes determining, by the computing system, a target cloud platform at which the object is stored, the target cloud platform being different from the first cloud platform. The method also includes translating, by the computing system, the received call to the first API into a call to a second API provided by the target cloud platform, the call to the second API including the request to implement the at least one lifecycle rule on the object. The method additionally includes communicating, by the computing system, the call to the second API to the target cloud platform. The method also includes receiving, by the computing system, from the target cloud platform, responsive to the call to the second API, a response consistent with the second API including a status of the object. The method further includes translating, by the computing system, the response consistent with the second API into a response consistent with the first API including the status of the object. The method additionally includes providing, by the computing system, the response consistent with the first API including the status of the object to the client.

In accordance with some other aspects of the present disclosure, a system is disclosed. The system includes a controller communicably coupled to a plurality of cloud platforms. The controller is configured to receive from a client, a call to a first application programming interface (API) associated with a first cloud platform, the call including a request to implement at least one lifecycle rule on an object. The controller is further configured to determine a target cloud platform at which the object is stored, the target cloud platform being different from the first cloud platform. The controller is also configured to translate the received call to the first API into a call to a second API provided by the target cloud platform, the call to the second API including the request to implement the at least one lifecycle rule on the object. The controller is additionally configured to communicate the call to the second API to the target cloud platform. The controller is further configured to receive from the target cloud platform, responsive to the call to the second API, a response consistent with the second API including a status of the object. The controller is also configured to translate the response consistent with the second API into a response consistent with the first API including the status of the object. The controller is additionally configured to provide the response consistent with the first API including the status of the object to the client.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 shows additional details of a controller virtual machine shown in FIG. 1, in accordance with some embodiments of the present disclosure.

FIG. 3 shows a flow diagram of an example process for orchestrating workloads on one or more cloud platforms, in accordance with some embodiments of the present disclosure.

FIG. 4 shows a flow diagram of a process for managing lifecycles of one or more objects stored on one or more cloud platforms, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to handling operations requested to be run on one or more cloud platforms. The requests can be received at a computing system or a node that includes a hypervisor, one or more virtual machines, and one or more controller virtual machine. The controller virtual machine can receive the requests and direct the operations to one or more cloud platforms.

One technical problem encountered in such computing systems is that the requesting client may get locked-in to a particular cloud platform. For example, requests to a cloud platform are limited to that cloud platform. This limitation can reduce the efficiency that can otherwise be achieved if the client has available resources at more than one cloud platforms.

The discussion below provides at least one technical solution to the technical problem mentioned above. In particular, an orchestration engine can process requests for operations from a client, and distribute the workload associated with the requested operations over a plurality of cloud platforms. This solution improves the utilization of resources over multiple cloud platforms, thereby improving the efficiency and the performance of operations requested by the client. The orchestration engine can provide a universal API to the clients 250, which can call the universal APIs to execute operations. The orchestration engine can translate the calls to the universal APIs into calls to APIs of selected cloud platforms over which the workload is distributed. The orchestration engine can also provide lifecycle management of objects stored in the cloud platforms. Here to, the orchestration engine can translate calls to implement lifecycle management rules any cloud platform on which the object is stored. This alleviates the need for any modifications to the client software, or for inclusion of additional APIs in the for each cloud platform available to the client. This, in turn, can improve the speed and performance of the computer system.

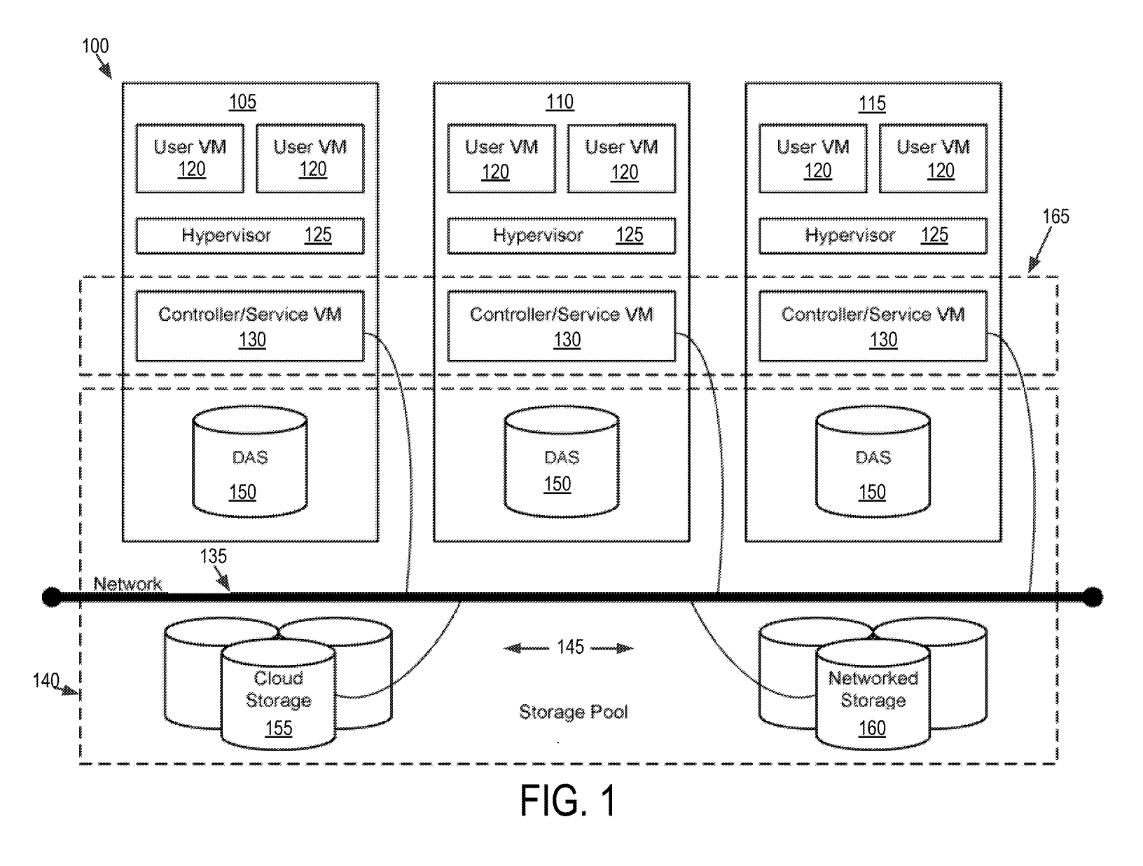

Referring now to FIG. 1, a virtual computing system 100 is shown, in accordance with some embodiments of the present disclosure. The virtual computing system 100 may be part of a datacenter. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other.

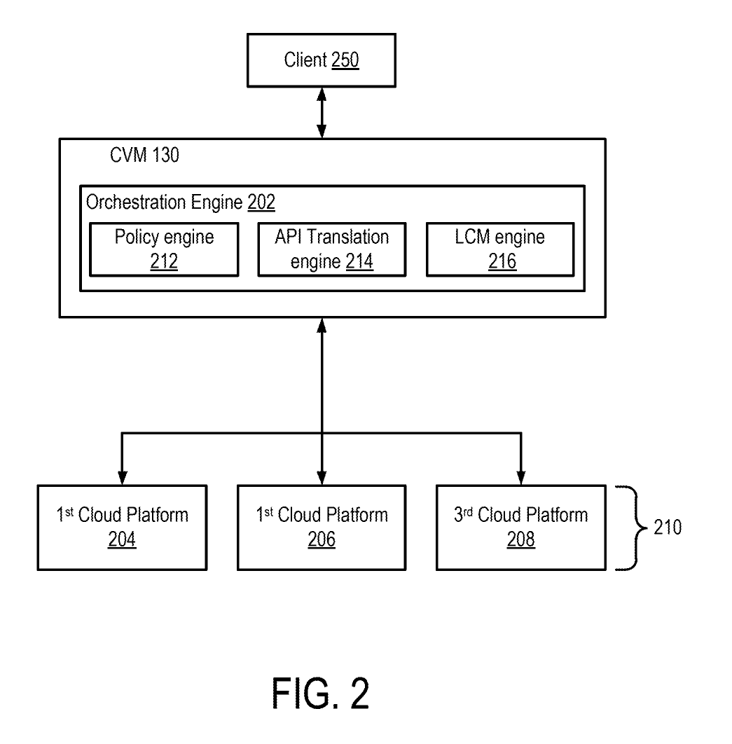

FIG. 2 shows additional details of the controller virtual machine (CVM) 200, in accordance with some embodiments of the present disclosure. In particular, the CVM 200 can be used to implement at least a portion of the CVM 130 shown in FIG. 1. The CVM 200 can include an orchestration engine 202 that provides an interface to deploy and manage objects on the one or more cloud platforms, such as a first cloud platform 204, a second cloud platform 206, and a third cloud platform 208 (collectively referred to herein as “the cloud platforms 210”). The orchestration engine 202 can include a policy engine 212, an API translation engine 214, and a lifecycle management (LCM) engine 216. The orchestration engine 202 can provide an interface between the cloud platforms 210 and the users, such as one or more clients 250 running the nodes (e.g., the first node 105, the second node 110, and the third node 115). In particular, the clients 250 can be entities such as hypervisors or other orchestration engines. The orchestration engine can provide a cloud agnostic interface to the clients 250, in such a manner that the type of the cloud platforms is hidden from the clients 250. To that end, the orchestration engine 202 can provide a set of universal APIs that the clients 250 can use to create and manage objects. The orchestration engine 202 can receive requests, such as creating objects (e.g., a virtual machine) on a cloud platform. The orchestration engine 202 can include a set of policies based on which the orchestration engine 202 can determine which one of the cloud platforms 210 the object should be created. Based on the selected cloud platform, the orchestration engine 202 can translate the universal API into an API specific to the selected cloud platform. The orchestration engine 202 can use the translated API to communicate with the selected cloud platform to create the object. Thereafter, the orchestration engine 202 can maintain the lifecycle of the created object on the selected cloud platform. For example, the orchestration engine can maintain a set of rules that can specify the various operations, such as start-up, shutdown, delete, etc., that can be carried out on one or more objects stored in the cloud platforms 210. The orchestration engine can execute the operations and provide current status and results or the operations to the clients 250.

The cloud platforms 210 can include public cloud platforms, private cloud platforms, and hybrid cloud platforms. Public cloud platforms include those platforms where cloud resources (such as servers and storage) are operated by a third-party cloud service provider and delivered over a network, such as the Internet. With a public cloud, all hardware, software, and other supporting infrastructure is owned and managed by the cloud service provider. Examples of public cloud platforms can include, without limitation, Amazon S3 (Simple Storage Service), Microsoft Azure, Google Cloud Platform, Nutanix Acropolis, and the like. Private cloud platforms include those platforms where the cloud resources are exclusively owned and operated by one business or organization. The cloud resources may be physically located at the organization's on-site data center, or cane be located by a third-party service provider. But, the cloud resources, services, and resources are maintained on a private network. Hybrid clouds can combine on-premises infrastructure of private clouds with public clouds. Data and applications can be moved between the private and public clouds, which provide greater flexibility and deployment options.

As mentioned above, the orchestration engine 202 can include a policy engine 212. The policy engine 212 can process requests received from the clients 250 to assign workloads to one or more cloud platforms 210. The workload associated with a request can include the type and amount of processing that the cloud platform may have provide to execute the requested operation. For example, the orchestration engine 202 can include operations that a cloud platform may have to carry out to execute a client request. For example, a request for creating images of a VM at a cloud platform may include the workload of creating the requested number of images of an identified VM. In another example, creating a web-server may include the workload of creating as well as running the webserver. The workloads can be processor intensive, memory intensive, or both. The policy engine 212 can maintain a capacity available at one or more cloud platform of the cloud platforms 210. For example, the policy engine 212 can maintain information regarding the amount of capacity, in terms of resources, such as memory and processing, that a client 250 is subscribed to at a cloud platform. The policy engine 212 can determine the resources that may be utilized for executing the requested workload. Based on the subscribed resources on the cloud, and the resources utilized by the workload, the policy engine 212 can determine which of the cloud platforms the client 250 is subscribed to can be used for executing a workload.

In one or more embodiments, the policy engine 212 may include predefined policies based on which the policy engine 212 may select one or more cloud platforms to execute a workload associated with a client request. For example, in one or more embodiments, the policies may include a load balancing policy, where the workload is distributed at a specified proportion among all the available cloud platforms. For instance, if two cloud platforms from the cloud platforms 210 are available, the policy engine 212 can select both the cloud platforms to run a portion of the workload. The distribution of the workload among the cloud platforms may be predetermined. Such as, for example, the policy associated with the requesting client 250 may specify an equal distribution of the workload. In some other instances, the distribution may be dynamic and based on the current availability of resources on the candidate cloud platforms.

The API translation engine 214 can provide the clients 250 a vendor neutral API or a universal API, which the client 250 can utilize to run their operations. The universal API can provide the clients 250 with the convenience of calling APIs that do not vary based on the cloud platform on which the client requests the operation be run. That is, the user can call the same universal API regardless of the cloud platform on which the requested operation is to be run. In one or more embodiments, the API translation engine 214 can translate, if needed, the platform specific API calls to API calls associated with the target or selected platform on which the operations are to be run. For example, API calls made by the client 250 to one or more cloud platforms can be routed through or intercepted by the API translation engine 214, and translated into an API call for a selected or target cloud platform. For example, the API translation engine 214 can convert APIs calls associated with one or more cloud platforms, such as, for example, the Amazon S3, Microsoft Azure, Google Cloud platform, Nutanix Acropolis cloud platform, and the like, into another one of the above mentioned cloud platforms. The translated API calls can be consistent with the cloud platform to which the APIs calls are sent. The target or selected cloud platform can be provided by the policy engine 212 or the LCM engine 216.

The LCM engine 216 can allow the clients 250 to define lifecycle management of objects stored on one or more cloud platforms. For example, the LCM engine 216 can allow the clients 250 to set rules related to the status of the one or more objects stored on a cloud platform. The LCM engine 216 may also provide to the client 250 responses received from the cloud platforms. In one or more embodiments, the LCM engine 216 can communicate with management modules of one or more cloud platforms to implement lifecycle management rules and to retrieve the statuses of the objects. In some such embodiments, the LCM engine 216 can send API calls to the management modules of the cloud platforms to run operations and query statuses of objects stored on the cloud platform.

In one or more embodiments, the LCM engine 216 can implement lifecycle rules that can carry out certain operations on one or more objects stored on the cloud platform based on one or more conditions. Example operations can include Start-up, Shutdown, Upgrade, Backup, Migration, Suspend, Create Template, Spawn, Scale, Image Create, and the like. Example conditions can include Age, Capacity, Time of creation, and other conditions. Lifecycle management provided by the LCM engine 216 can be particularly helpful in instances where use of data stored in the cloud platform becomes less frequent over time. In some such instances, the LCM engine 216 can specify rules that can archive the stored objects to another cloud platform or to a different type of storage on the same cloud platform after a predefined period of time.

The LCM engine 216 can utilize the API translation engine 214 to translate the universal API calls or platform specific API calls into API calls associate with the target or selected cloud platform. The LCM engine 216 may also utilize the API translation engine 214 to translate responses received from the cloud platforms into universal API responses or into data that can be sent to the client.

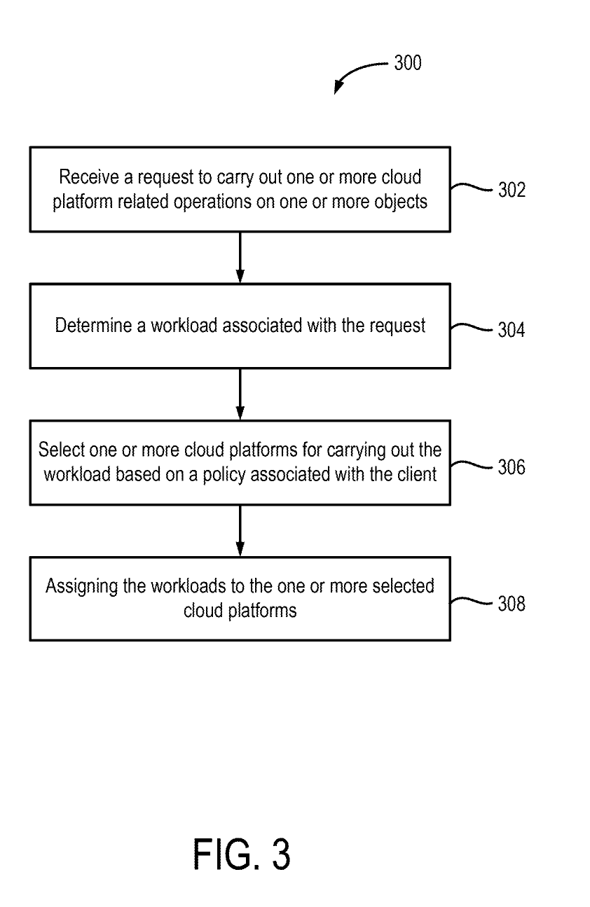

FIG. 3 shows a flow diagram of an example process 300 for orchestrating workloads on one or more cloud platforms. Additional, fewer, or different operations may be performed depending on the embodiment. In particular, the process 300 can be utilized by the orchestration engine 202 discussed above in relation to FIG. 2. The process 300 includes receiving a request to carry out one or more cloud platform related operations on one or more objects (operation 302). As an example, the CVM 130 can receive a request for operations on or associated with one or more objects from one or more clients 250. The operations can include object management operations such as, for example, Start-up, Shutdown, Upgrade, Backup, Migration, Suspend, Create Template, Spawn, Scale, Image Create, and the like. Of course, other operations can also be received in the request. In one or more embodiments, the request can be received in the form of an API call to a universal API provided by the API translation engine 214. The universal API can provide a suite of operations that the client 250 can utilize to perform operations on objects on a cloud platform. In some other embodiments, the request can be in the form of an API call to an API of one or more cloud platforms, such as, for example, the Amazon S3 cloud platform, the Microsoft Azure cloud platform, the Nutanix Acropolis cloud platform, the Google Cloud Platform, and the like. In such instances, the API call can be received in a format that is consistent with one of these cloud platforms. For example, a request for an object operation on Amazon S3 may include an API call in the REST API format that is consistent with the formatting specified by the Amazon S3 API.

The process 300 further includes determining a workload associated with the request (operation 304). As discussed above, the orchestration engine 202 can manage workload across multiple platforms based on policies specified by the client. In managing the workload, the orchestration engine determines the processing and storage resources that may be desired for carrying out the operations requested by the client. For example, if the client requests creating multiple images of a virtual machine on the cloud, the orchestration engine 202 can determine the processing and the storage resources that would be needed to creating the multiple images. As another example, the client 250 can request running a web server at one or the cloud platforms, and the orchestration engine 202 can determine the processing and storage resources that may be needed to create and run the web server on a cloud platform. In one or more embodiments, the orchestration engine 202 can store in memory a list of operations and the resources needed for carrying out each of the listed operations. In some other embodiments, the orchestration engine 202 can query the cloud platforms 210 to determine the resources needed by each cloud platform to carry out the specified operation.

The process 300 also includes available resources at one or more cloud platforms (operation 306). As discussed above, the orchestration engine 202 can determine the processing and or storage resources available at one or more cloud platforms from the cloud platforms 210. The orchestration engine 202 can communicate with the cloud platforms to determine the processing and storage resources available to the client 250 based on the client's subscription at the cloud platform. For example, during initial subscription, a client may pay for a given amount of processing resources or storage at a cloud platform. The orchestration engine 202 can communicate with each cloud platform on which the client 250 has a subscription to determine the available resources.

The process 300 further includes selecting one or more cloud platforms for carrying out the workload based on a policy associated with the client (operation 306). The orchestration engine 202 can maintain a policy for distribution of the workload to one or more cloud platforms. In one or more embodiments, the policy may specify the number of cloud platforms, which have the available resources, to use for distributing the workload. As an example, the policy may specify selecting those cloud platforms that have available resources above a threshold value (e.g., more than 10 GB storage). Based on this policy, the orchestration engine 202 can select the appropriate cloud platforms. As another example, the policy may also specify the distribution of the workload among the available cloud platforms. For example, the policy may specify to evenly distribute the workloads over the available cloud platforms. In another example, the policy may specify to distribute the workload proportional to the available resources at the cloud platforms. That is a first cloud platform with twice the available resources than a second cloud platform can be assigned with twice the workload assigned to the second cloud platform. The policy may also take into consideration the costs associated with executing the workloads on the cloud platform. For example, the policy may specify a dollar amount threshold that may not be exceeded at one or more cloud platforms. The orchestration engine 202 can estimate the cost that may be incurred in executing the workload on each cloud platform, and select only those cloud platforms that do not exceed the threshold.

The process 300 further includes assigning the workloads to the selected one or more cloud platforms (operation 308). The orchestration engine 202 can send the workloads to the selected cloud platforms. In one or more embodiments, the orchestration engine 202 may translate and modify the requests received from the client 250 into requests that are specific to the selected cloud platforms. For example, the client 250 may use a universal API to send their requests, or may send requests using the APIs associated with a particular cloud platform. The orchestration engine 202 can translate the API calls received by the client 250 into API calls specific to the selected cloud platforms. The API engine 212 can provide the translation of the API calls from one format to another, based on the target cloud platform specified by the orchestration engine 202. In one or more embodiments, orchestration engine 202 can translate the request from the client 250 into two or more API calls directed to two or more cloud platforms over which the workload is distributed. For example if the client request was to create 20 images of a VM, the orchestration engine 202 may create two API calls for two cloud platforms. Each of the two API calls may include requests to the respective cloud platform to create 10 images of the VM.

The process 300 discussed above can be executed for each request received by the CVM 130. The process 300 may also include maintaining a record of the assignment of workloads associated with each received request from a client. This can allow the orchestration engine 202 to direct subsequent requests to the appropriate objects on the appropriate cloud platforms.

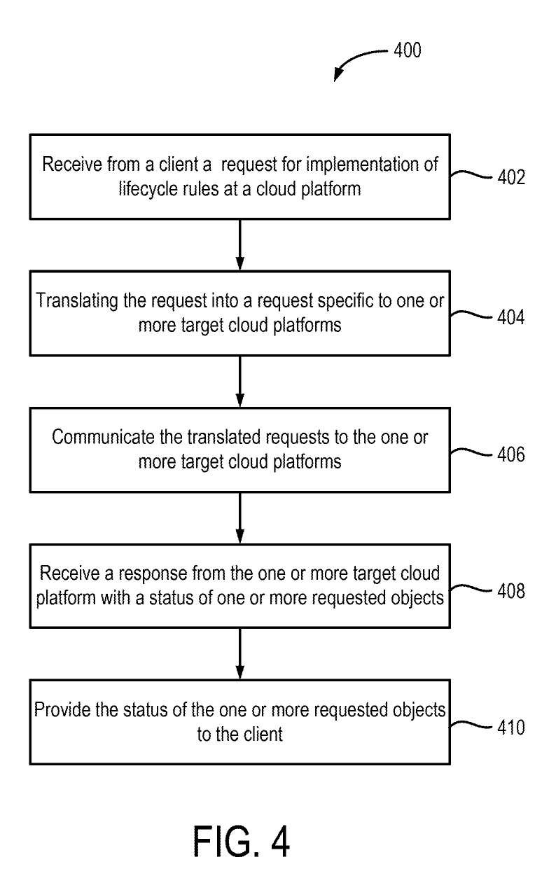

FIG. 4 shows a flow diagram of a process 400 for managing lifecycles of one or more objects stored on one or more cloud platforms. Additional, fewer, or different operations may be performed depending on the embodiment. As discussed above, the LCM engine 216 can maintain the lifecycles of objects that are stored on the cloud platforms, and provide to the client, data associated with the status of the objects. The process 400 includes receiving from a client 250 a request for implementation of lifecycle rules at a cloud platform (operation 402). As mentioned above, the LCM engine 216 can receive lifecycle management rules from the clients 250 for one or more objects stored or running on one or more cloud platforms. The rules can include at least one operation and at least one condition. The operation can include for example, Start-up, Shutdown, Upgrade, Backup, Migration, Suspend, Create Template, Spawn, Scale, Image Create, and the like. The condition can include Time, Age, Capacity, Available resources, etc. In one or more embodiments, the requests from the client 250 may be received over the universal API provided by the API engine 212. Alternatively, the requests may include API calls to the APIs provided by one or more cloud platforms, such as the Amazon S3 cloud platform, the Microsoft Azure cloud platform, the Nutanix Acropolis cloud platform, the Google Cloud Platform, and the like.

The process 400 can further include translating the requests into request specific to one or more target cloud platforms (operation 404). As mentioned above, the clients 250 may user the use the universal API calls supported by the API engine 212 to send lifecycle management requests. Alternatively, the clients 250 can use cloud platform specific API calls to provide lifecycle management requests. Based on these requests, the LCM engine 216 can determine the target cloud platform at which the lifecycle management requests is to be executed. For example, the request can include the identity of one or more objects for which the lifecycle request is to be implemented. If the object has been stored by the orchestration engine 202 at a particular cloud platform, the LCM engine 216 can look up the list of objects and the corresponding cloud platform where the objects are stored to determine the target cloud platform. In some other embodiments, the lifecycle request can include the identity of the cloud platform where the object is stored. The LCM engine 216 can then translate the received lifecycle management request to a request in the format that is consistent with the target cloud platform. For example, the LCM engine 216 may translate a request received as a universal API call into an Amazon S3 API call if the target cloud platform is the Amazon S3 cloud platform. In one or more embodiments, the API translation engine 214 can store translations of API calls associated with one cloud platform (including universal APIs) into API calls associated with other cloud platforms. In this manner, the LCM engine 216 communicate with the API translation engine 214 to have the client 250 requests translated into API calls for the target cloud platform. Once translated the LCM engine 216 can communicate the translated requests to the target cloud platform (operation 406).

The process further includes receiving responses from the one or more target cloud platform (operation 408). The one or more target cloud platforms can respond to the received lifecycle management requests with a response that can include the status of the one or more objects stored on running on the target cloud platforms. For example, the LCM engine 216 can receive from each of the target cloud platforms, the current status of each object indicated in the request. The status can include indicators such as “running,” “standby,” “deleted,” etc. The status may also include the size of the object stored in the cloud platform, the version of the object (indicating changes to the object), and the like. In one or more embodiments, the status can be received in a format that is specific to the cloud platform.

The process also includes providing the status of the requested objects to the client (operation 410). The LCM engine 216, upon receiving the status information from the target cloud platform, can translate the status results into a format understood by the client. As an example, the LCM engine 216 can translate the status information received from the target cloud platform into a format that is the same as the format in which the original lifecycle request for that object was received. For example, if the original lifecycle request received from the client 250 was an API call associated with the Amazon S3 cloud platform, the LCM engine 216 can translate the status information from the received format into the Amazon S3 cloud platform and provide the response to the client.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, by a computing system, from a client, a call to an application programming interface (API), the call including a request to carry out a cloud platform operation;
determining, by the computing system, a workload associated with the request, the workload including the cloud platform operation;
selecting, by the computing system, a cloud platform from a plurality of cloud platforms to execute the cloud platform operation;
and
translating, by the computing system, the cloud platform operation into an API call specific to the selected cloud platform.

2. The method of claim 1, further comprising selecting, by the computing system, the cloud platform based on available processing or storage resources available at the cloud platform.

3. The method of claim 2, further comprising: communicating, by the computing system, with the selected cloud platform to determine the available processing or storage resources available at the cloud platform.

4. The method of claim 1, further comprising: equally distributing, by the computing system, a plurality of cloud platform operations among a plurality of cloud platforms.

5. The method of claim 1, further comprising: distributing, by the computing system, a plurality of cloud platform operations among a plurality of cloud platforms proportional to respective available storage resources.

6. The method of claim 1, further comprising: maintaining, by the computing system, a record of assignment of the cloud platform operation to the respective cloud platform.

7. An apparatus comprising:
a controller communicably coupled to a plurality of cloud platforms, having programmed instructions to:
receive, from a client, a call to an application programming interface (API), the call including a request to carry out a cloud platform operation;
determine a workload associated with the request, the workload including the cloud platform operation;
select a cloud platform from a plurality of cloud platforms to execute the cloud platform operation;
translate the cloud platform operation into an API call specific to the selected cloud platform.

8. The apparatus of claim 7, wherein the controller further includes programmed instructions to select the cloud platform one from a plurality of cloud platforms based on available processing or storage resources available at the cloud platform.

9. The apparatus of claim 8, wherein the controller further includes programmed instructions to communicate with the cloud platform to determine the available processing or storage resources available at the cloud platform.

10. The apparatus of claim 7, wherein the controller further includes programmed instructions to equally distribute a plurality of cloud platform operations among a plurality of cloud platforms.

11. The apparatus of claim 7, wherein the controller further includes programmed instructions to distribute a plurality of cloud platform operations among a plurality of cloud platforms proportional to available storage resources of a respective cloud platform.

12. The apparatus of claim 7, wherein the controller further includes programmed instructions to maintain a record of assignment of the cloud platform operation to the respective cloud platform.

13. A method, comprising:
determining, by a computing system, a target cloud platform at which an object is stored, the target cloud platform being different from the first cloud platform;
translating, by the computing system, a received call to a first application programming interface (API) into a call to a second API provided by the target cloud platform, the call to the second API including the request to implement at least one lifecycle rule on the object;
communicating, by the computing system, the call to the second API to the target cloud platform;
receiving, by the computing system, from the target cloud platform, responsive to the call to the second API, a response consistent with the second API including a status of the object;
translating, by the computing system, the response consistent with the second API into a response consistent with the first API including the status of the object; and
providing, by the computing system, the response consistent with the first API including the status of the object to the client.

14. The method of claim 13, wherein the request to implement the at least one lifecycle rule on the object includes at least one operation and at least one condition, which when satisfied, causes the operation to be executed.

15. The method of claim 14, wherein the at least one operation includes deleting the object.

16. The method of claim 13, further comprising: receiving, by the computing system, an identity of the object; and
determining, by the computing system, the target cloud platform based on looking up a list including identities of objects and corresponding cloud platforms where the objects are stored.

17. A non-transitory computer-readable computer medium having instructions stored that when executed perform a method comprising:
receiving from a client, a call to a first application programming interface (API) associated with a first cloud platform, the call including a request to implement at least one lifecycle rule on an object;
determining a target cloud platform at which the object is stored, the target cloud platform being different from the first cloud platform;
translating the received call to the first API into a call to a second API provided by the target cloud platform;
communicating the call to the second API to the target cloud platform;
receiving from the target cloud platform, responsive to the call to the second API, a response consistent with the second API including a status of the object;
translating the response consistent with the second API into a response consistent with the first API including the status of the object; and
providing the response consistent with the first API including the status of the object to the client.

18. The non-transitory computer-readable computer medium of claim 17, wherein the method further comprises receiving the request to implement the at least one lifecycle rule on the object includes at least one operation and at least one condition, which when satisfied, causes the operation to be executed.

19. The non-transitory computer-readable computer medium of claim 17, wherein the at least one operation includes deleting the object.

20. The non-transitory computer-readable computer medium of claim 17, wherein the method further comprises receiving an identity of the object; and
determining the target cloud platform based on a look up operation on a list including identities of objects and corresponding cloud platforms where the objects are stored.
